(19) United States
(12) Patent Application Publication
(10) Pub. No.: US 2024/0417613 A1
(43) Pub. Date: Dec. 19, 2024

(54) Phase Change Material for Ultra-Low Temperature Protection

(71) Applicant: Insolcorp LLC, Albemarle, NC (US)

(72) Inventors: Peter Franz Horwath, New London, NC (US); Michael Roscoe DUNN, Concord, NC (US)

(73) Assignee: Insolcorp LLC, Albemarle, NC (US)

(21) Appl. No.: 18/210,737

(22) Filed: Jun. 16, 2023

(51) Int. Cl. C09K 5/06

(52) U.S. Cl. CPC C09K 5/066

(57) ABSTRACT

A composition is disclosed of 40% to 55% by weight inorganic bromide salt (ammonium bromide, sodium bromide, potassium bromide, or calcium bromide); 50% to 60% by weight demineralized water; and 0.5% to 2% by weight nucleating agent. The composition has a melting point of about −65° C. to about −75° C. Also disclosed are methods of making the composition, a phase change material (PCM) including the composition in a container, and methods of use.

This disclosure relates to compositions for use as phase change materials (PCMs) for ultra-low temperature (ULT) protection. Such compositions and materials are used in the field of storage and transportation of heat-sensitive products.

Such heat-sensitive products may include, for example, high-value pharmaceuticals and other medical products, such as biological drugs, cells, tissues, and organs. Such products may require storage at temperatures well below the freezing point of water. Such products are also at risk for loss of ability to maintain required ULT if a primary cooling system malfunctions due to a power outage or equipment failure.

Thus, a need exists for cost-effective and safe PCMs that can provide ULT storage for heat-sensitive materials, e.g., as an alternative to dry ice, and that can also provide holdover in case of ULT freezer failure.

### SUMMARY

This disclosure relates to a composition that includes 40% to 55% by weight of an inorganic bromide salt that is ammonium bromide, sodium bromide, potassium bromide, or calcium bromide; 50% to 60% by weight demineralized water; and 0.5% to 2% by weight nucleating agent.

In one aspect, the inorganic bromide salt is calcium bromide.

In another aspect, the composition is contained within a sealed airtight container to provide a phase change material (PCM) for ultra-low temperature (ULT) protection.

In another aspect, the composition includes a coloring agent in an amount sufficient to change the composition appearance from opaque when in a frozen state to semi-transparent or clear when in a melted state. The composition may be a first color or shade when in a frozen state, and a second color or shade when in a melted state.

This disclosure also relates to a method of making a PCM, by (a) stirring an aqueous inorganic bromide salt and water in a mixing tank at about room temperature, wherein the inorganic bromide salt is present at 40% to 55% by weight and is ammonium bromide, sodium bromide, potassium bromide, or calcium bromide; (b) adding a nucleating agent to the stirred mixture at a rate sufficiently slow to avoid coagulation of nucleating agent; and (c) stirring the mixture resulting from step (b) until the bromide salt dissolves completely to form a PCM containing undissolved particles of the nucleating agent, and wherein the PCM comprises 50% to 60% by weight demineralized water and 0.5% to 2% by weight nucleating agent.

This disclosure also provides a method for storing perishable items, by positioning a container containing the composition (“a PCM brick”) in a freezer, wherein the PCM brick provides (a) extended temperature hold time during freezer malfunction or power outage, and/or (b) permits increased temperature setpoint of the freezer.

### BRIEF DESCRIPTION OF THE FIGURES

FIG. 1 shows a PCM brick being loaded into a portable freezer.

FIG. 2A is an individual PCM brick showing typical dimensions for fitting within standard Nunc™ racks in most freezers. FIG. 2B shows color/opacity change in liquid state (left brick: green and semi-transparent or clear) versus frozen state (right brick: white and opaque).

FIG. 3A shows PCM bricks loaded in a standard rack.

FIG. 3B shows a ULT freezer loaded with a kit of PCM bricks.

FIG. 3C illustrates use of PCM bricks loaded into freezer units, directly on shelves and using a rack.

FIG. 4 is a chart of test data showing additional hold time provided by PCM bricks in a ULT freezer.

FIG. 5 shows field test results of energy savings for ULT freezers at different setpoints.

### DETAILED DESCRIPTION

The composition includes 40% to 55% by weight inorganic bromide salt that is ammonium bromide, sodium bromide, potassium bromide, or calcium bromide. The composition includes less than 5% of other inorganic salts, preferably less than 2% or even less than 0.5% of other inorganic salts. In some cases, the composition contains less than 0.1% of other inorganic salts or is substantially free of other inorganic salts. The inorganic bromide salt is preferably calcium bromide, more preferably anhydrous calcium bromide.

The composition also includes 50% to 60% by weight water. In some embodiments the composition contains 53% to 55% by weight water. The water is preferably demineralized water or distilled water.

The nucleating agent is present in the composition at about 0.5% to about 2% by weight, preferably about 0.8% to about 1.2% by weight, or even about 1% by weight. When the composition is in the liquid form, the nucleating agent is present to some degree as solid particles dispersed in the liquid, with sufficient solid particles present to promote solidification when at or below the composition's freezing point. Examples of suitable nucleating agents include NH₄Cl, BaCO₃, Na₂WO₄, KCl, SrCl₂, TiO₂, SiO₂, carbon black, or graphite, or mixtures thereof.

The coloring agent may be any dye or pigment present in an amount sufficient to change the composition appearance in a detectable manner when the composition is in a liquid or solid state. For example, the appearance may change from opaque when in a frozen state to semi-transparent or clear when in a melted state, or the composition may be a first color or shade when in a frozen state, and a second color or shade when in a melted state. Suitable coloring agents include food coloring agents such as those classified by the U.S. Food and Drug Administration (FDA) and the European Union E number system. Exemplified herein are tartrazine and brilliant blue FCF. Other coloring agents may be used, provided that these result in a visual indicator of liquid versus frozen state of the composition.

The composition has a melting point of about −65° C. to about −75° C. In some embodiments the composition has a melting point of about −68° C. to about −72° C., preferably about −70° C. The composition could also have a melting point above −65° C., e.g., from about room temperature (25° C.) to about −65° C., or from about 25° C. to about 0° C., or a melting point below −65° C., e.g., from −65° C. to about 210° C. In this disclosure, the terms melting point and freezing point are used interchangeably.

The composition may be contained within a sealed container, preferably an airtight container with minimal residual air, to form a PCM for ULT protection. The container may be in “brick” form of size suitable for use in freezers used in the field. The container may be of any suitable size and material used in the field, e.g., a plastic bottle. The container is preferably made of a material including plastic or resin, e.g., polyvinyl chloride, polyethylene, in particular high-density polyethylene (HDPE), polypropylene, polyethylene terephthalate, polystyrene, nylon, or polyester, or combinations thereof.

The composition may be formulated to form a gel in the container, to minimize/eliminate leaking of the composition in the event of a rupture to the container. A gelling agent may be included in the composition, e.g., at 0.5% to 3% by weight. Preferably, the gelling agent compliments nucleation to improve crystallization time. Preferably, the gelling agent does not substantially compromise the coloring agent/visual conditioning indicator. The gelling agent may be, e.g., a derivative of guar gum such as biopolymer hydroxypropyl guar (HPG) or biopolymer carboxymethyl hydroxypropyl guar (CMHPG), a cellulose derivative such as hydroxyethyl cellulose (HEC), or xanthan gum.

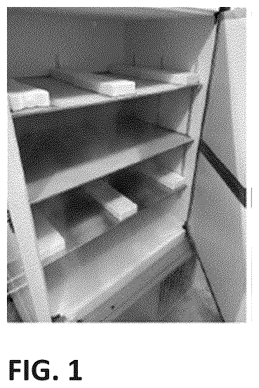

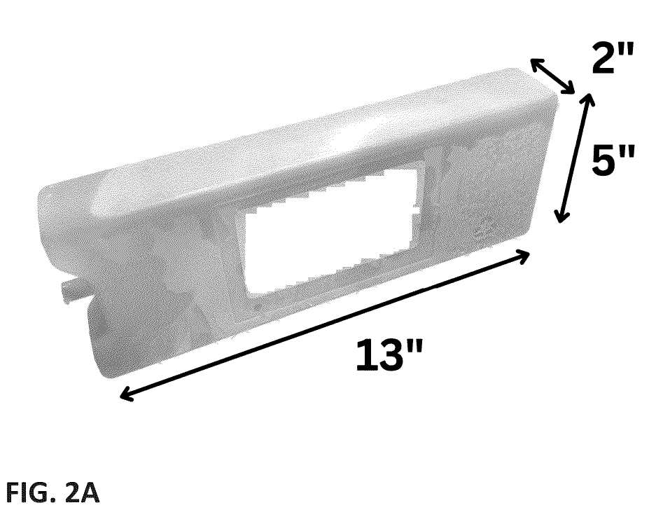

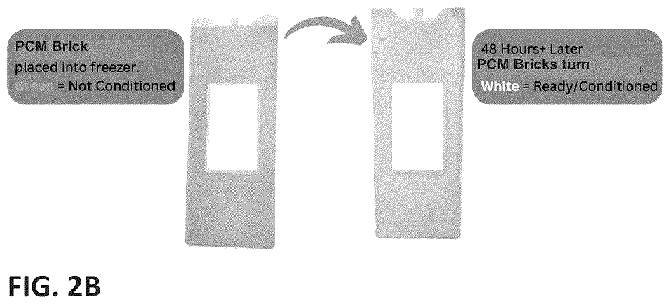

FIG. 1 shows an example of a PCM brick being loaded into a portable/ULT freezer. FIG. 2A shows a PCM brick with typical dimensions for fitting within standard Nunc™ racks. The specific dimensions of the PCM brick can vary, depending on the space constraints of intended use, however a typical embodiment of the invention would be a brick with a 5″×2″ cross section, and a length or design with sufficient surface area for efficient heat transfer to the surroundings (e.g., a freezer interior).

Preferably, the composition is visible from the exterior of the brick to permit visual confirmation of phase change and charge completion. FIG. 2B shows the difference in color and opacity in a brick in the liquid state (left brick: green and clear) versus a brick in the frozen state (right brick: white and opaque).

The color change can provide a visual indication that an interior space of a freezer has warmed excessively. The color change can also provide visual confirmation that the product is ready for use. For example, a PCM brick containing the PCM composition in liquid form requires “conditioning” by freezing for, e.g., 48 hours or longer at 80° C. or at a different setpoint depending on the freezer conditions. The PCM brick is considered “conditioned” when the corresponding color/opacity change occurs, e.g., from semi-transparent green to opaque white (as shown in FIG. 2B). Preferably, a brick should be for example 100% white in appearance before use in a freezer; if not, conditioning/cooling should be continued until a 100% color change is achieved, indicating that the brick is ready for use.

In a method of making the PCM, the inorganic bromide salt may be supplied as a salt brine or as a powder. The inorganic bromide salt as a powder is in some cases preferably anhydrous.

### EXAMPLES

### Materials:

Calcium Bromide Anhydrous—technical grade. Formula: CaBr₂; CAS Number: 7789-41-5; molecular weight: 199.88.
Calcium Chloride Brine 52%. Preferred supplier: ICL Group; appearance: clear solution; assay (as CaBr₂%): 52-54; density 20/20° C. (g/ml)<1.7.
Ammonium Chloride—technical grade. Formula: NH₄Cl; CAS Number: 12125-0209; purity 98%.
Coloring Agent: Wylton Kelly Green (composition: corn syrup, glycerin, sugar, deionized water, tartrazine, brilliant blue FCF, modified food starch, agar, citric acid, potassium sorbate, and sodium citrate).

Examples 1 and 2 below each yield a composition with relative amounts of components as follows: 45% CaBr₂, 54% water, 1% NH₄Cl.

### Example 1: CaBr₂ Brine Used to Prepare PCM

Calcium Bromide Brine 52% is added to a mixing tank at room temperature. Demineralized water (ambient temperature) is added to the mixing tank and the mixture is stirred for 45 minutes. Ammonium chloride is added as nucleating agent, ensuring no lumpy pieces of ammonium chloride are not included in the solution; lumpy pieces indicate water absorption. The coloring agent is then added, followed by stirring for 45 minutes. Stirring is continued without stopping until essentially complete or nearly complete dissolution is achieved, leaving at most only small amounts of nucleating agent particles visibly undissolved. Additives are added slowly as they generally are fine powder and will coagulate if poured into the mixture too quickly. The resulting product is packaged immediately or sealed in airtight container(s) with little residual air. The container is sufficiently transparent to permit visualization of color and opacity change upon melting/freezing (see FIG. 2C).

### Example 2: Anhydrous Calcium Bromide Used to Prepare PCM

Demineralized water (ambient temperature) is added to the mixing tank. Calcium Bromide Anhydrous is slowly added to the tank and the mixture is stirred for 45 minutes. Demineralized water (ambient temperature) is again added to the mixing tank and stirring is continued for 45 minutes. Ammonium chloride is added as nucleating agent, ensuring no lumpy pieces of ammonium chloride are not included in the solution; lumpy pieces indicate water absorption. The coloring agent is then added, followed by stirring for 45 minutes. Stirring is continued without stopping until essentially complete or nearly complete dissolution is achieved, leaving at most only small amounts of nucleating agent particles visibly undissolved. Additives are added slowly as they generally are fine powder and will coagulate if poured into the mixture too quickly. The resulting product is packaged immediately or sealed in airtight container(s) with little residual air.

### Example 2: Resiliency/Hold Time of PCM Brick in ULT Freezer

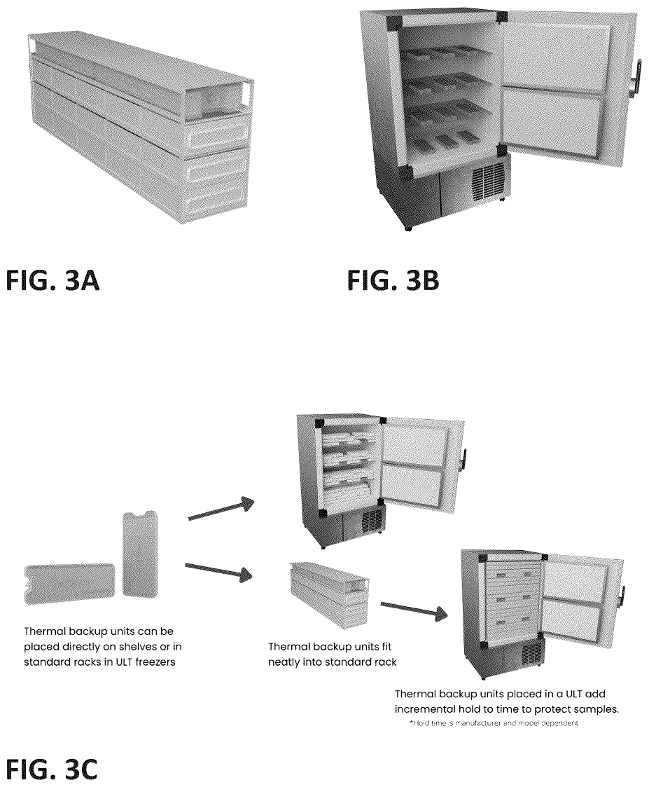

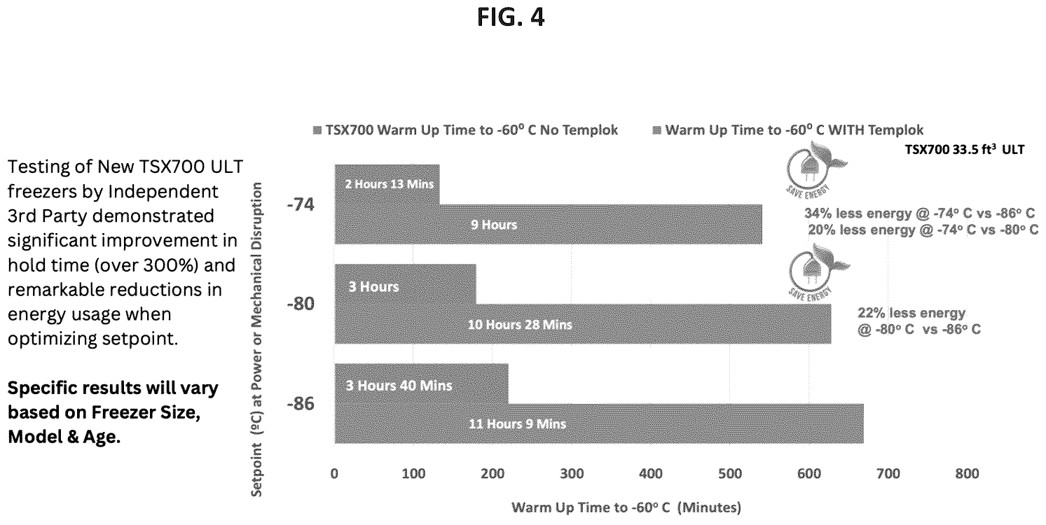

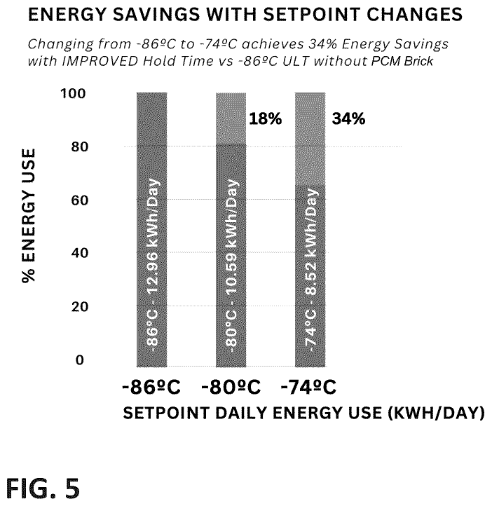

PCM bricks prepared by the methods of Examples 1 and 2 were tested in a Thermo-Fisher TSX600 ULT freezer. A kit of the PCM bricks set up in a ULT freezer (see FIG. 3C). The hold time was tested by measuring temperature versus time for a freezer with the PCM bricks (“With Templok”) compared to a freezer without PCM bricks (“Without Templok”). The results are shown in FIG. 4, demonstrating 8+ hours of additional hold from −86° C. to −60° C. time. FIG. 5 shows energy savings for ULT freezers with PCM bricks at different setpoints.

### Example 3: Energy Savings

FIG. 5 shows results of field testing ULT freezers at lower setpoints permitted by PCM bricks prepared by the methods of Examples 1 and 2. State of the art ULT freezers use less daily energy, but have only 4 hours of hold time during power interruption. As a result, freezers are generally kept at −86° C. to reduce risk of thermal damage to contents. The PCM bricks disclosed herein permit use of higher setpoints, thereby reducing energy costs. As shown in FIG. 5, field testing has shown that a setpoint of −80° C. provides 15% to 20% savings, and a setpoint of −74° C. provides 30% to 40% savings, compared to the standard −86° C. setpoint.

Those skilled in the art will understand that this invention may be embodied in many different forms and should not be construed as limited to the embodiments set forth in this application. Rather, these embodiments are provided so that this disclosure will fully convey the invention to those skilled in the art. Many modifications and other embodiments of the invention will come to mind in one skilled in the art to which this invention pertains having the benefit of the teachings presented herein. The contents of any references, pending patent applications, and published patents cited throughout this application are incorporated herein by reference in their entirety.

1. A composition, comprising:
(a) 40% to 55% by weight inorganic bromide salt that is ammonium bromide, sodium bromide, potassium bromide, or calcium bromide;
(b) 50% to 60% by weight demineralized water; and
(c) 0.5% to 2% by weight nucleating agent.

2. A composition according to claim 1, wherein the inorganic bromide salt is calcium bromide.

3. A composition according to claim 1, wherein the nucleating agent comprises NH4Cl, BaCO3, Na2WO4, KCl, SrCl2, TiO2, SiO2, carbon black, or graphite, or mixtures thereof.

4. A composition according to claim 1, wherein the composition has a melting point of about −65° C. to about −75° C.

5. A composition according to claim 4, wherein the composition has a melting point of about −70° C.

6. A composition according to claim 1, further comprising a coloring agent in an amount sufficient to change the composition appearance from opaque when in a frozen state to semi-transparent or clear when in a melted state.

7. A composition according to claim 6, wherein the composition is a first color or shade when in a frozen state, and a second color or shade when in a melted state.

8. A composition according to claim 7, wherein the coloring agent comprises a dye or pigment.

9. A composition according to claim 5, wherein the coloring agent comprises tartrazine or brilliant blue FCF.

10. A composition according to claim 1, further comprising a gelling agent.

11. A phase change material (PCM) for ultra-low temperature (ULT) protection, comprising a composition according to claim 1 contained within a sealed airtight container with minimal residual air.

12. A PCM according to claim 10, wherein the composition is visible from the exterior of the container to permit visual confirmation of phase change and charge completion.

13. A PCM according to claim 10, wherein the container has size and shape suitable for use in a freezer.

14. A PCM according to claim 10, wherein the cross section dimensions of the container is about 5″×2″, to fit within a standard Nunc™ box rack or drawer used within a ULT freezer.

15. A method of making a PCM, comprising:
(a) stirring an aqueous inorganic bromide salt and water in a mixing tank at about room temperature, wherein the inorganic bromide salt is present at 40% to 55% by weight and is ammonium bromide, sodium bromide, potassium bromide, or calcium bromide;
(b) adding a nucleating agent to the stirred mixture at a rate sufficiently slow to avoid coagulation of nucleating agent; and
(c) stirring the mixture resulting from step (b) until the bromide salt dissolves completely to form a PCM containing undissolved particles of the nucleating agent, wherein the PCM comprises 50% to 60% by weight demineralized water and 0.5% to 2% by weight nucleating agent.

16. A method according to claim 14, wherein the inorganic bromide salt is calcium bromide, and wherein the nucleating agent comprises NH4Cl, BaCO3, Na2WO4, KCl, SrCl2, TiO2, SiO2, carbon black, or graphite, or mixtures thereof.

17. A method according to claim 14, wherein the PCM has a melting point of about −65° C. to about −75° C.

18. A method according to claim 14, wherein the PCM has a melting point of about −70° C.

19. A method according to claim 14, further comprising adding a coloring agent and stirring until completely dissolved, wherein the coloring agent is present in an amount sufficient to change the solution appearance from opaque when in a frozen state to semi-transparent or clear when in a melted state.

20. A method according to claim 14, wherein the coloring agent comprises a dye or pigment.

21. A composition according to claim 18, wherein the coloring agent comprises tartrazine or brilliant blue FCF.

22. A method according to claim 14, further comprising a step of packaging the PCM in a sealed airtight container with minimal residual air.

23. A method according to claim 21, wherein the composition is visible from the exterior of the container to permit visual confirmation of phase change and charge completion.

24. A method according to claim 14, wherein the container has size and shape suitable for use in a freezer.

25. A method for storing perishable items, comprising positioning a container containing a PCM according to claim 10 in a freezer, wherein the PCM provides (a) extended temperature hold time during freezer malfunction or power outage, or (b) increased temperature setpoint of the freezer.
